(19) United States
(12) Patent Application Publication
(10) Pub. No.: US 2026/0114594 A1
(43) Pub. Date: Apr. 30, 2026

(54) METHOD FOR MANAGING EYEBROW, WEARABLE DEVICE AND STORAGE MEDIUM

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHENG-CHING CHIEN, New Taipei (TW); XIANG HUANG, Shenzhen (CN)

(21) Appl. No.: 19/179,058

(22) Filed: Apr. 15, 2025

(30) Foreign Application Priority Data
Jul. 19, 2024 (CN) 202410977357.9

(51) Int. Cl. A45D 44/00; G06V 10/74; G06V 10/75; G06V 10/764; G06V 40/16

(52) U.S. Cl. CPC A45D 44/005; G06V 10/75; G06V 10/761; G06V 10/764; G06V 40/161; G06V 40/172; A45D 2044/007

(57) ABSTRACT

The present disclosure relates to a technical field of virtual reality and augmented reality, and provides a method for managing an eyebrow, a wearable device and a storage medium. The method includes determining a first face type of a user by scanning a head of the user, and determining a recommended eyebrow shape based on a preset recommendation rule and the first face type, and calculating a first matching coefficient between the recommended eyebrow shape and a current eyebrow shape, and generating suggestion information for managing the current eyebrow shape based on the first matching coefficient.

### FIELD

The subject matter herein generally relates to a field of virtual reality and augmented reality, and in particular to a method for managing an eyebrow and a wearable device and a storage medium.

### BACKGROUND

As an important part of shaping facial lines and overall makeup, eyebrow shaping has attracted much attention from fashion industry and public.

With the development of technology, users can use a series of professional beauty software to detect and evaluate the shape of the eyebrow and provide suggestions for shaping the eyebrow. However, this method for managing the eyebrow usually requires photo input or video input, which is less efficient and accurate.

### BRIEF DESCRIPTION OF THE DRAWINGS

In order to more clearly illustrate a technical solution of an embodiment of the present disclosure, drawings required in description of the embodiment of the present disclosure will be briefly introduced below. Obviously, the drawings described below are only some embodiments of the present disclosure. For those skilled in the art, other drawings can be obtained based on these drawings without paying any creative labor.

FIG. 1 is a schematic diagram of an application scenario of a method for managing an eyebrow provided in an embodiment of the present disclosure.

FIG. 2 is a schematic diagram of another application scenario of a method for managing an eyebrow provided in an embodiment of the present disclosure.

FIG. 3 is a flowchart of an embodiment of a method for managing an eyebrow provided in the present disclosure.

FIG. 4 is an example image of a face shape of an user provided in an embodiment of the present disclosure.

FIG. 5 is an example diagram of a preset facial database provided in another embodiment of the present disclosure.

FIG. 6 is an example image of a current eyebrow shape provided by an embodiment of the present disclosure.

FIG. 7 is an example diagram of a preset eyebrow shape database provided in an embodiment of the present disclosure.

FIG. 8 is a schematic diagram of functional modules of an eyebrow management device provided in an embodiment of the present disclosure.

FIG. 9 is a structural diagram of a wearable device provided in an embodiment of the present disclosure.

### DETAILED DESCRIPTION

The following will describe the technical solutions in embodiments of the present disclosure clearly and completely in conjunction with the accompanying drawings in the embodiments of the present disclosure. Obviously, the described embodiments are part of the embodiments of the present disclosure, not all of the embodiments. Based on the embodiments in the present disclosure, all other embodiments obtained by ordinary technicians in the field without creative work are within the scope of protection of the present disclosure.

The terms “first” and “second” are used for descriptive purposes only and should not be understood as indicating or implying relative importance or implicitly indicating the number of indicated technical features in the following description. Thus, features defined as “first” and “second” may explicitly or implicitly include one or more of the features. In description of the embodiments of the present disclosure, words such as “exemplary” or “for example” are used to indicate examples, illustrations or explanations. Any embodiment or design described as “exemplary” or “for example” in the embodiments of the present disclosure should not be interpreted as being more preferred or more advantageous than other embodiments or designs. Specifically, the use of words such as “exemplary” or “for example” is intended to present related concepts in a concrete way.

Unless otherwise defined, all technical and scientific terms used herein have the same meaning as those generally understood by technicians in the technical field in the present disclosure. The terms used in the specification of the present disclosure are only for the purpose of describing specific embodiments and are not intended to limit the present disclosure. It should be understood that, unless otherwise specified in the present disclosure, “/” means or. For example, A/B represents A or B. “And/or” in the present disclosure is only a description of an association relationship of associated objects, indicating that three relationships exist. For example, A and/or B can represent: A exists alone, A and B exist at the same time, and B exists alone. “At least one” means one or more. “Multiple” means two or more than two. For example, at least one of a, b or c represents seven situations. That is, a, b, c, a and b, a and c, b and c, a, b and c.

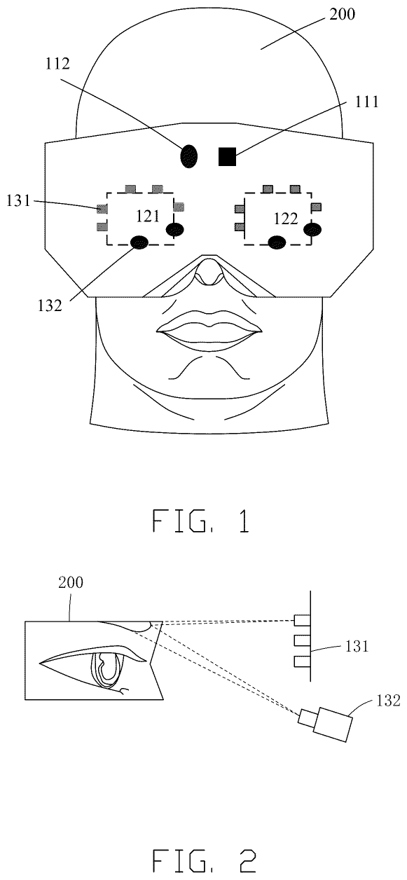

Please refer to FIG. 1, which is an example diagram of an application scenario of a method for managing an eyebrow provided in an embodiment of the present disclosure. As shown in FIG. 1, a wearable device 100 is worn on a user's head 200, and the wearable device 100 includes a camera device, a display device, and an eye tracking device. Among them, the camera device includes an infrared (IR) transmitter 111 and an IR receiver 112. The display device includes a first display screen 121 and a second display screen 122. The eye tracking device includes a light emitting diode (LED) transmitter 131 and an IR camera 132.

In a process of managing the eyebrow, the wearable device 100 may obtain a three-dimensional structure diagram of the user's head 200 by using structured light technology through the IR transmitter 111 and the IR receiver 112 and generate a digital human face shape of the user according to the three-dimensional structure diagram and determine a first face type of the user according to the digital human face shape. After determining the first face type of the user, the wearable device 100 determines a recommended eyebrow shape based on a preset recommendation rule and the first face type. Among them, the recommended eyebrow shape may be a better eyebrow shape suitable for the user's face. In order to determine whether the user's current eyebrow shape needs to be trimmed or determine how to trim the current eyebrow shape, the wearable device 100 may calculate a first matching coefficient between the recommended eyebrow shape and the current eyebrow shape and generate suggestion information for managing the current eyebrow shape based on the first matching coefficient. The wearable device 100 may prompt the user to trim the eyebrow and provide eyebrow trimming suggestions through the suggestion information. The method may effectively improve an efficiency and accuracy for managing the eyebrow.

In some embodiments, the wearable device may display the suggestion information for managing the eyebrow through the first display screen 121 and/or the second display screen 122, or may provide the suggestion information through voice. The embodiments of the present disclosure do not limit a way to prompt the suggestion information.

In some embodiments, as shown in FIG. 2, the wearable device 100 may capture the current eyebrow shape of the user by the LED transmitter 131 and an IR camera 132 of the eye tracking device.

In some embodiments, the wearable device 100 may be a pair of smart glasses, such as a pair of virtual reality (VR) glasses, a pair of augmented reality (AR) glasses, a pair of mixed reality (MR) glasses, etc. The camera of the camera device of the wearable device 100 may be a depth infrared camera.

FIG. 1 is only an illustrative example, and the method for managing the eyebrow provided in the present disclosure may also be applied in other scenarios. For example, in some scenarios, the wearable device 100 may also include a microphone. In some scenarios, the wearable device 100 may also include an information processing device. in some scenarios, other types of components or modules may also be included. The embodiments of the present disclosure do not limit the specific application scenarios of the method for managing the eyebrow.

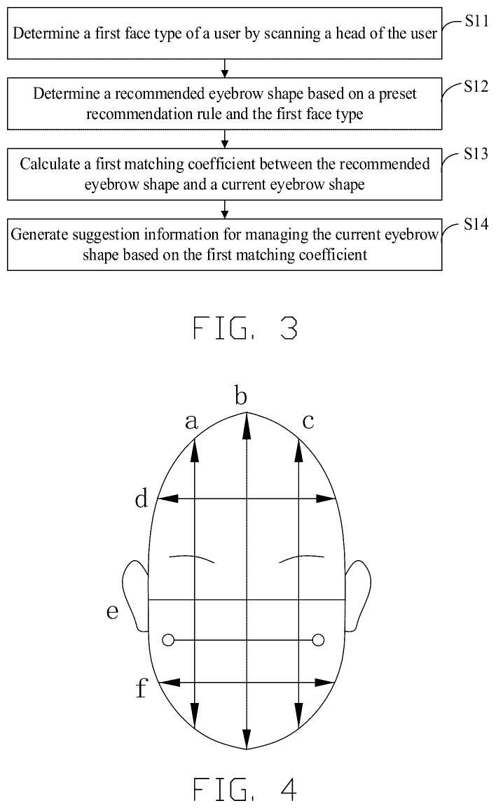

Please refer to FIG. 3, which is a flowchart of an embodiment of a method for managing an eyebrow provided in an embodiment of the present disclosure. The method is applied to a wearable device, and the embodiment of the present disclosure is described by taking the method applied to the wearable device 100 in FIG. 1 as an example. The method includes the following steps.

S11, the wearable device determines a first face type of a user by scanning a head of the user.

In some embodiments, the first face type indicates a face type of the user's face. The face type includes but is not limited to a long face, a square face, a heart-shaped face, a round face, a diamond-shaped face, etc. The embodiment of the present disclosure does not limit the face type.

In some embodiments, different face types are usually suitable for different eyebrow shapes. Choosing an eyebrow shape suitable for a face shape may better balance facial features and enhance overall beauty. For example, a long face is suitable for thick flat eyebrows, a square face is suitable for tail eyebrows, a heart-shaped face is suitable for willow-leaf eyebrows, a round face is suitable for European eyebrows, and a diamond-shaped face is suitable for small European eyebrows. Therefore, in the process of managing the user's eyebrow shape, the wearable device may determine the first face type of the user, and determine a better eyebrow shape suitable for the user's face based on the first face type, so as to manage the user's eyebrow shape based on the better eyebrow shape, such as providing eyebrow trimming prompt and eyebrow trimming suggestion.

In this embodiment, the wearable device may determine the first face type of the user by scanning the user's head through a camera or a video camera. For example, the wearable device obtains the three-dimensional structure diagram of the user by using the depth infrared camera to scan the user's head and generate a digital human model of the user according to the three-dimensional structure diagram. The wearable device determines the first face type of the user according to a face type of the digital human face of the digital human model.

In other embodiments, the wearable device may also obtain facial features of the user based on face recognition technology and identify the first face type of the user based on the facial features.

In some embodiments of the present disclosure, the wearable device determines a first face type of a user by scanning a head of the user includes: the wearable device obtains a digital human face shape of the user by scanning the head of the user, and determines a second face type of the digital human face shape based on a first face parameter of the digital human face shape, and determines the first face type of the user based on the second face type.

In some embodiments, the first face parameter includes but is not limited to a geometric feature parameter of the digital human face (such as a length, a width, etc.), a color parameter, a facial proportion size parameter (such as a proportion size from an eye to a forehead, a proportion size from a chin to a lip, a proportion size from the chin to the eyes etc.), etc.

In some embodiments, the wearable device may obtain the digital human model corresponding to the user's head by scanning the user's head. The digital human face type corresponding to the digital human model is the same as the user's face type corresponding to the user's head, so that the wearable device may determine the first face type of the use by determining the second face type of the digital human face type.

In some embodiments, the wearable device may obtain a first face parameter of the digital human face shape and determine a second face shape type of the digital human face based on the first face parameter of the digital human face shape.

In some embodiments of the present disclosure, the wearable device determines the second face type of the digital human face shape based on the first face parameter of the digital human face shape includes: obtaining a second face parameter of a reference face shape from a preset facial database, calculating a second matching coefficient between the digital human face shape and the reference face shape based on the first face parameter and the second face parameter; determining a target reference face shape matched with the digital human face shape from the preset facial database based on the second matching coefficient; and determining the second face type based on a third face type of the target reference face shape.

In some embodiments, the preset facial database stores at least one reference face shape and a face shape type corresponding to each reference face shape. The third face type indicates the face shape type corresponding to the target reference face shape. The second face parameter include but is not limited to a geometric feature parameter (such as a length, a width, etc.), a color parameter, a facial proportion size parameter (such as a proportion size from an eye to a forehead, a proportion size from a chin to a lip, a proportion size from the chin to the eyes and so on) of the reference face shape. The second matching coefficient may be used to characterize a similarity between different face shapes. Generally, the higher the second matching coefficient, the higher the similarity between different face shapes.

In this embodiment, the wearable device may compare the digital human face shape with the reference face shape of the preset face shape database based on the first face parameter of the digital human face shape and the second face parameter of the reference face shape of the preset face shape database, and determine a target reference face shape that is more similar to the digital human face shape from the preset face shape database, so that the wearable device may use the third face type corresponding to the target reference face shape as the second face type of the digital human face shape, and then determine the first face type of the user or the user's face according to the second face type of the digital human face shape.

In the process of determining the target reference face shape that is relatively similar to the digital human face shape from a preset face shape database, the wearable device may obtain a second face parameter of the reference face shape in the preset face shape database, and calculate a second matching coefficient between the digital human face shape and the reference face shape based on the first face parameter and the second face parameter. After obtaining the second matching coefficient between the digital human face shape and each reference face shape of the preset face shape database, the wearable device may select the reference face shape corresponding to a largest second matching coefficient as the target reference face shape, and determine the second face type of the digital human face shape according to the third face type of the target reference face shape.

In other embodiments, the wearable device may also set a first threshold, and in response that the second matching coefficient between the digital human face shape and the reference face shape is greater than the first threshold, the wearable device may use the reference face shape as the target reference face shape. The first threshold may be customized according to the first face parameter and the second face parameter.

In other embodiments, the wearable device may also determine the target reference face shape in other ways. The embodiment of the present disclosure does not limit the method for determining the target reference face shape.

In this embodiment, in the process of calculating the second matching coefficient between the digital human face shape and the reference face shape based on the first face parameter and the second face parameter, the wearable device may calculate the second matching coefficient based on a geometric feature parameter of the digital human face shape and a geometric feature parameter of the reference face shape. For example, the second matching coefficient between the digital human face shape and the reference face shape may be calculated based on a length and a width of the digital human face shape and a length and a width of the reference face shape.

In the process of calculating the second coefficient between the digital human face and the reference face based on the length and width of the digital human face shape and the length and width of the reference face shape, the wearable device may take multiple length values and multiple width values of the digital human face shape, and multiple length values and multiple width values of corresponding positions of the reference face shape, and calculate the second matching coefficient between the digital human face shape and the reference face shape by calculating a length ratio and a width ratio of each corresponding position of the digital human face shape and the reference face shape.

For example, the wearable device may divide the digital human face shape into multiple parts according to a length direction and divide the reference face shape into multiple parts according to a width direction. For example, the wearable device may obtain multiple equable parts of the digital human face shape by dividing the digital human face shape according to the length direction, and the wearable device may obtain multiple equable parts of the digital human face shape by dividing the digital human face shape according to the width direction. The wearable device may obtain multiple equable parts of the reference face shape by dividing the reference face shape according to the length direction, and the wearable device may obtain multiple equable parts of the reference face shape by dividing the reference face shape according to the width direction. Among them, the number of equal divisions of the digital human face shape in the length direction is the same as the number of equal divisions of the reference face shape in the length direction, and the number of equable parts of the digital human face shape in the width direction is the same as the number of equable parts of the reference face shape in the width direction. For example, in response that the digital human face shape is divided into four equal parts in the length direction and four equal parts in the width direction, then the reference face shape involved in the calculation is also divided into four equal parts in the length direction and four equal parts in the width direction. The wearable device may correspond the digital human face shape to the equal division lines of the reference face shape one by one according to the position of the equal division line, and calculate a ratio between a first equal division line of the digital human face shape and a second equal division line of the reference face shape corresponding to the first equal division line. And the ratio is calculated by dividing a smaller value of the first equal division line and the second equal division line by a larger value of the first equal division line and the second equal division line. The wearable device may use an accumulated value of the ratio as the second matching coefficient of the digital human face shape and the reference face shape.

As an example, the digital human face shape shown in FIG. 4, the wearable device divides the digital human face shape into four equal parts in the width direction through the equal division lines a, b, and c, and divides the digital human face shape into four equal parts in the length direction through the equal division lines d, e, and f. As shown in FIG. 5, the preset face shape database stores reference face shapes A, B, C, D, and E. Taking the calculation of the second matching coefficient between the digital human face shape and the reference face shape A as an example, according to the division method of the digital human face shape, the wearable device divides the reference face shape A into four equal parts in the width direction through the equal division lines a1, b1, and c1, and divides the reference face shape A into four equal parts in the length direction through the equal division lines d1, e1, and f1. Then, the wearable device may respectively determine the values of a and a1, b and b1, c and c1, d and d1, e and e1, and f and f1. Taking a is less than a1, b is less than b1, c is less than c1, d is less than d1, e is equal to e1, and f is less than f1 as an example, the wearable device may respectively calculate the ratios of a/a1, b/b1, c/c1, d/d1, e/e1 or e1/e, f/f1, and use sum of the ratios of a/a1, b/b1, c/c1, d/d1, e/e1 or e1/e, f/f1 as the second matching coefficient between the digital human face shape and the reference face shape A.

In other embodiments, the wearable device may also calculate the second matching coefficient between the digital human face shape and the reference face shape by calculating a sum of differences between a length difference and a width difference between the digital human face shape and the reference face shape or a weighted sum of the differences.

In other embodiments, the wearable device may also calculate the second matching coefficient between the digital human face shape and the reference face shape according to other parameters of the first face parameter and the second face parameter. The embodiment of the present disclosure does not limit the method of calculating the second matching coefficient between the digital human face shape and the reference face shape.

In some embodiments, before calculating the second matching coefficient between the digital human face shape and the reference face shape based on the first face parameter and the second face parameter, the wearable device may pre-process the digital human face shape or the reference face shape. For example, the wearable device aligns the digital human face shape with the reference face shape in terms of resolution, pixels, etc., so that the digital human face shape and the reference face shape are comparable.

In this embodiment, the wearable device obtains multiple length values and multiple width values by finely dividing the digital human face shape and the reference face shape and calculates the second matching coefficient between the digital human face shape and the reference face shape according to the multiple length values and the multiple width values, thereby effectively improving the face shape matching accuracy.

It is understood that in other embodiments, the position and number of the equal division lines may be set by oneself. For example, the wearable device may divide the digital human face into multiple parts in the length direction and the width direction, such as dividing the face according to three courtyards and five eyes, and the position of the equal division lines of the digital human face and the reference face shape are matched one by one. The embodiment of the present disclosure does not limit the position and number of the equal division lines of the face shape.

S12, the wearable device determines a recommended eyebrow shape based on a preset recommendation rule and the first face type.

In some embodiments, the recommended eyebrow shape represents a better eyebrow shape suitable for the user's face shape.

In some embodiments of the present disclosure, a recommended eyebrow shape is determined based on the preset recommendation rule and the first face type, including: determining a target reference eyebrow shape matched with the first face shape from a preset eyebrow shape database according to a preset correspondence relationship; and determining the recommended eyebrow shape based on a preferred eyebrow shape of the user and the target reference eyebrow shape.

In some embodiments, the preset eyebrow shape database stores at least one reference eyebrow shape and the type of each reference eyebrow shape. The type of the eyebrow shape includes but is not limited to, a thick flat eyebrow, a tail eyebrow, a willow-leaf eyebrow, a European eyebrow, a small European eyebrow, etc. The present disclosure does not limit the type of eyebrow shape. Usually, the preset eyebrow shape database stores a lot of reference eyebrow shapes to ensure the efficiency and accuracy of eyebrow shape management.

In some embodiments, the preset correspondence relationship includes correspondence relationship between face types and reference eyebrow shapes. The face type includes but is not limited to a long face, a square face, a heart-shaped face, a round face, a diamond-shaped face, etc. The embodiment of the present disclosure does not limit the face type.

Usually, different face types are suitable for different eyebrow types. Choosing an eyebrow shape that suits the face type may better balance facial features and enhance the overall beauty. For example, a long face is suitable for thick flat eyebrows, a square face is suitable for tail eyebrows, a heart-shaped face is suitable for willow-leaf eyebrows, a round face is suitable for European eyebrows, and a diamond-shaped face is suitable for small European eyebrows. Therefore, the wearable device may pre-establish a preset correspondence relationship between the reference eyebrow shapes and the face types. After determining the user's first face type, the wearable device may determine the target reference eyebrow shape matched with the first face type from the preset eyebrow shape database according to the preset correspondence relationship. The target reference eyebrow shape is an eyebrow shape that is more suitable for the user's face shape.

Furthermore, in order to make the final recommended eyebrow shape meet the user's personalized needs and improve the personalization level of the recommended eyebrow shape, the wearable device may obtain the preferred eyebrow shape of the user and determine the recommended eyebrow shape based on the preferred eyebrow shape and the target reference eyebrow shape.

In some embodiments, the wearable device may obtain the preferred eyebrow shape of the user in the following manner: obtain a set of eyebrow shapes of the user, the set of eyebrow shapes includes multiple eyebrow shape types of the eyebrow of the user; determine the eyebrow shape of the user that is frequently used by the user from the set of eyebrow shapes; and set the eyebrow shape that is frequently used by the user as the preferred eyebrow shape.

Further, after determining the preferred eyebrow shape of the user, the wearable device may detect whether the preferred eyebrow shape exists in the preset eyebrow shape database. In response that the preferred eyebrow shape does not exist in the preset eyebrow shape database, the wearable device may update the preferred eyebrow shape and the corresponding type to the preset eyebrow shape database.

In other embodiments, the wearable device may also obtain the preferred eyebrow shape of the user from the following ways. The wearable device may obtain multiple eyebrow shapes of the user, which are eyebrow shapes used by the user, and determine the eyebrow shape that the user uses more frequently from the multiple eyebrow shapes, and compare the eyebrow shape that the user uses more frequently with the reference eyebrow shapes in the preset eyebrow shape database, and determine a reference eyebrow shape that is similar to the eyebrow shape that the user uses more frequently. And the wearable device may use the eyebrow shape that the user uses more frequently or the reference eyebrow shape that is similar to the eyebrow shape that the user uses more frequently as the user's preferred eyebrow shape, and determine the type of the user's preferred eyebrow shape based on the type of the reference eyebrow shape that is similar to the user eyebrow shape that the user uses more frequently.

In other embodiments, the wearable device may also determine the preferred eyebrow shape of the user by other means, for example, predicting the preferred eyebrow shape by a deep learning network model. The embodiment of the present disclosure does not limit the method of determining the preferred eyebrow shape of the user.

In some embodiments of the present disclosure, a recommended eyebrow shape is determined based on a preferred eyebrow shape and a target reference eyebrow shape, including: in response that a type of the preferred eyebrow shape is the same as the target reference eyebrow shape, the preferred eyebrow shape or the target reference eyebrow shape is determined to be the recommended eyebrow shape; in response that the type of the preferred eyebrow shape is different from the target reference eyebrow shape, the user is prompted to determine the recommended eyebrow shape from the preferred eyebrow shape and the target reference eyebrow shape, and the recommended eyebrow shape is determined from the preferred eyebrow shape and the target reference eyebrow shape by receiving a feedback message from the user.

In some embodiments, in order to ensure stability, efficiency and accuracy for managing the eyebrow shape, the wearable device usually determines a recommended eyebrow shape as a better eyebrow shape suitable for the user's face shape. Therefore, in the process of determining the recommended eyebrow shape according to the preferred eyebrow shape and the target reference eyebrow shape, in response that the type of the preferred eyebrow shape is the same as the type of the target reference eyebrow shape, the wearable device may use any one of the preferred eyebrow shape and the target reference eyebrow shape as the recommended eyebrow shape. In response that the type of the preferred eyebrow shape is different from the type of the target reference eyebrow shape, the wearable device may send a message to the user to prompt the user to determine the recommended eyebrow shape from the preferred eyebrow shape and the target reference eyebrow shape and receive a feedback message from the user.

In some embodiments, a method to prompt the user includes but is not limited to any one or more of voice, text display, vibration prompt, LED light flashing prompt, SMS prompt, email prompt, etc.

S13, the wearable device calculates a first matching coefficient between the recommended eyebrow shape and a current eyebrow shape.

In some embodiments, the first matching coefficient between the recommended eyebrow shape and the current eyebrow shape is used to represent a similarity between the recommended eyebrow shape and the current eyebrow shape. By calculating the first matching coefficient between the recommended eyebrow shape and the current eyebrow shape, it may be determined whether the current eyebrow shape is a recommended eyebrow shape suitable for the user's face shape. The wearable device manages the current eyebrow shape according to the first matching coefficient, which may effectively improve the efficiency and accuracy for managing the eyebrow shape. For example, in response that the current eyebrow shape deviates greatly from the recommended eyebrow shape according to the first matching coefficient, the wearable device may prompt the user to trim the current eyebrow shape, and may generate trimming suggestions based on the difference between the recommended eyebrow shape and the current eyebrow shape, and provide the trimming suggestions to the user to improve the similarity between the trimmed eyebrow shape and the recommended eyebrow shape.

In some embodiments of the present disclosure, calculating the eyebrow shape matching coefficient between the recommended eyebrow shape and the current eyebrow shape includes obtaining a first parameter of the current eyebrow shape and a second parameter of the recommended eyebrow shape; and calculating the first matching coefficient between the recommended eyebrow shape and the current eyebrow shape according to the first parameter and the second parameter

In some embodiments, the first parameter includes but is not limited to a geometric feature parameter of the current eyebrow shape (such as an eyebrow length, an eyebrow width, an arc radius of the current eyebrow shape and so no), a color parameter, etc. The second eyebrow shape parameters include but are not limited to a geometric feature parameter of the recommended eyebrow shape (such as an eyebrow length, an eyebrow width, an arc radius of the recommended eyebrow shape and so on), a color parameter, etc.

In this embodiment, in the process of calculating the first matching coefficient between the recommended eyebrow shape and the current eyebrow shape according to the first parameter and the second parameter, the wearable device may calculate the first matching coefficient according to a combined feature parameter of the current eyebrow shape and the geometric feature parameter of the recommended eyebrow shape. For example, the wearable device may calculate the first matching coefficient according to a length, a width, and an arc radius of the current eyebrow shape and a length, a width, and an arc radius of the recommended eyebrow shape. Or the wearable device may calculate the first matching coefficient according to the length and width of the current eyebrow shape and the length and the arc radius of the recommended eyebrow shape. Or the wearable device may calculate the first matching coefficient according to the length and the arc radius of the current eyebrow shape and the length and the arc radius of the recommended eyebrow shape. Or the wearable device may calculate the first matching coefficient according to the width and the arc radius of the current eyebrow shape and the width and the arc radius of the recommended eyebrow shape. Or the wearable device may calculate the first matching coefficient according to the length of the current eyebrow shape and the length of the recommended eyebrow shape. Or the wearable device may calculate the first matching coefficient according to the width of the current eyebrow shape and the width of the recommended eyebrow shape. Or the wearable device may calculate the first matching coefficient according to the arc radius of the current eyebrow shape and the arc radius of the recommended eyebrow shape.

In other embodiments, the wearable device may also calculate the first matching coefficient between the recommended eyebrow shape and the current eyebrow shape based on the recommended eyebrow shape, other parameters in the corresponding geometric feature parameters of the current eyebrow shape, or other eyebrow shape parameters. The embodiment of the present disclosure does not limit the method for determining the first matching coefficient.

In some embodiments, before calculating the first matching coefficient between the recommended eyebrow shape and the current eyebrow shape based on the first parameter and the second parameter, the wearable device may pre-process the recommended eyebrow shape or the current eyebrow shape, for example, aligning the resolution, pixels, etc., to ensure that the recommended eyebrow shape is comparable to the current eyebrow shape.

In some embodiments of the present disclosure, the first parameter includes a first length, a first width, and a first arc radius of the current eyebrow shape, the second parameter includes a second length, a second width, and a second arc radius of the recommended eyebrow shape. The wearable device calculates the first matching coefficient between the recommended eyebrow shape and the current eyebrow shape according to the first parameter and the second parameter by calculating a first difference between the first eyebrow length and the second eyebrow length based on a preset rule, calculating a second difference between the first eyebrow width and the second eyebrow width based on the preset rule, calculating a third difference between the first arc radius and the second arc radius based on the preset rule, and calculating the first matching coefficient between the recommended eyebrow shape and the current eyebrow shape according to the first difference, the second difference and the third difference.

In some embodiments, the first difference may be a ratio between the first eyebrow length and the second eyebrow length, or a difference between the first eyebrow length and the second eyebrow length and so on. The second difference may be a ratio between the first eyebrow width and the second eyebrow width, or difference between the first eyebrow width and the second eyebrow width and so on. The third difference may be a ratio between the first arc radius and the second arc radius, or a difference between the first arc radius and the second arc radius and so on. The embodiment of the present disclosure does not limit the specific expression of the first difference, the second difference, and the third difference, but the specific expression of the first difference, the second difference, and the third difference must be consistent. For example, when the first difference is the ratio between the first eyebrow length and the second eyebrow length, the second difference is the ratio between the first eyebrow width and the second eyebrow width, and the third difference is the ratio between the first arc radius and the second arc radius. When the first difference is the difference between the first eyebrow length and the second eyebrow length, the second difference is the difference between the first eyebrow width and the second eyebrow width, and the third difference is the difference between the first arc radius and the second arc radius.

In some embodiments, when the first difference, the second difference, and the third difference are in the form of ratios, the wearable device calculates the ratio by dividing the smaller eyebrow shape parameter by the corresponding larger eyebrow shape parameter according to the preset rules. For example, in response that the first eyebrow length is less than the second eyebrow length, the first eyebrow width is less than the second eyebrow width, and the first arc radius is less than the second arc radius, then the first difference is the ratio of the first eyebrow length to the second eyebrow length, the second difference is the ratio of the first eyebrow width to the second eyebrow width, and the third difference is the ratio of the first arc radius to the second arc radius. At this time, the wearable device may use the sum of the first difference, the second difference, and the third difference as the first matching coefficient of the current eyebrow shape and the recommended eyebrow shape. In this case, the larger the first matching coefficient, the greater the similarity between the current eyebrow shape and the recommended eyebrow shape. In response that the first matching coefficient is small, it indicates that the similarity between the current eyebrow shape and the recommended eyebrow shape is small.

In some embodiments, in order to improve the matching accuracy between the current eyebrow shape and the recommended eyebrow shape, and thus improve the accuracy for managing the eyebrow shape, the wearable device may select multiple first eyebrow widths at multiple positions of the current eyebrow shape. For example, correspondingly, the wearable device may select the same number of second eyebrow widths at corresponding positions of the recommended eyebrow shape. Taking the second difference as a ratio as an example, in response that the second difference parameter is used, the wearable device may respectively calculate the ratio between the first eyebrow width and the corresponding second eyebrow width to obtain multiple second differences.

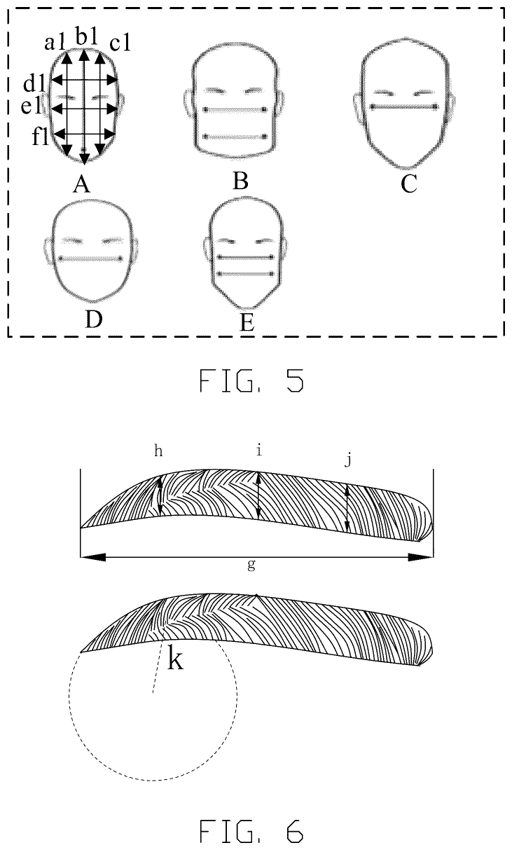

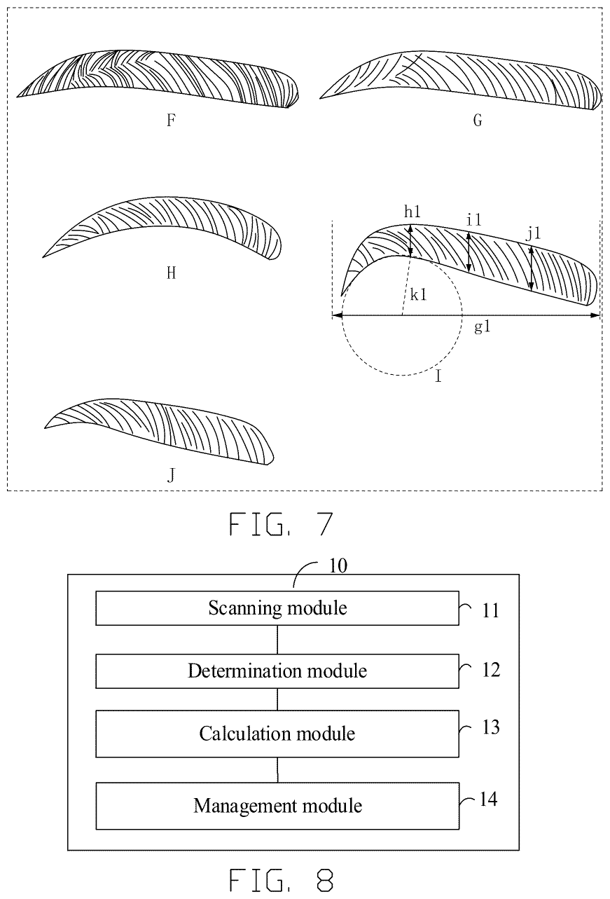

As an example, for the current eyebrow shape shown in FIG. 6 the first eyebrow length of the current eyebrow shape is represented as g, and the wearable device divides the current eyebrow shape into four equal parts through the equal division lines h, i, and j. Width of the equal division lines h, i, and j may all represent the first eyebrow width of the current eyebrow shape. k represents the first arc radius of the current eyebrow shape. As shown in FIG. 7, taking the reference eyebrow shape I as the recommended eyebrow shape as an example, corresponding to the reference eyebrow shape, the wearable device divides the recommended eyebrow shape into four equal parts through the equal division lines h1, i1, and j1. Width of the equal division lines h1, i1, and j1 may all represent the second eyebrow width of the recommended eyebrow shape. k1 represents the second arc radius of the recommended eyebrow shape. g1 represents the second eyebrow length of the recommended eyebrow shape. The specific expression form of the first difference, the second difference, and the third difference is a ratio form, and the first eyebrow length g is less than the second eyebrow length g1, the first eyebrow width h is less than the second eyebrow width h1, the first eyebrow width i is less than the second eyebrow width i1, the first eyebrow width j is less than the second eyebrow width j1, and the first arc radius k is greater than the second arc radius k1. Thus, the first difference is equal to g/g1, the second difference includes h/h1, i/i1, j/j1, and the third difference is equal to k/k1. The first matching coefficient between the current eyebrow shape and the recommended eyebrow shape is the sum of g/g1, h/h1, i/i1, j/j1, and k/k1.

In some embodiments, the first difference, the second difference, and the third difference may also be a difference form. In this case, the wearable device may use an absolute difference between the first eyebrow length and the second eyebrow length as the first difference, an absolute difference between the first eyebrow width and the second eyebrow width as the second difference parameter, and an absolute difference between the first arc radius and the second arc radius as the third difference according to the preset rules. At this time, the wearable device may use the sum of the first difference, the second difference, and the third difference as the first matching coefficient between the current eyebrow shape and the recommended eyebrow shape, and the smaller the first matching coefficient, the greater the similarity between the current eyebrow shape and the recommended eyebrow shape. When the eyebrow shape matching coefficient is large, it indicates that the similarity between the current eyebrow shape and the recommended eyebrow shape is small.

In other embodiments, the wearable device may calculate the first matching coefficient between the current eyebrow shape and the recommended eyebrow shape according to any one or more of the first difference, the second difference, and the third difference. For example, the wearable device may use the sum of the first difference and the second difference as the first matching coefficient between the current eyebrow shape and the recommended eyebrow shape, or may determine the first matching coefficient between the current eyebrow shape and the recommended eyebrow shape according to the sum of the first difference and the third difference. The embodiment of the present disclosure does not limit the method of calculating the first matching coefficient between the current eyebrow shape and the recommended eyebrow shape.

S14, the wearable device generates suggestion information for managing the current eyebrow shape based on the first matching coefficient.

In some embodiments, the suggestion information may include prompt information that the current eyebrow shape needs to be trimmed, trimming suggestion information for trimming the current eyebrow shape, etc. The suggestion information may be customized, and the embodiment of the present disclosure does not limit the specific setting of the suggestion information.

In some embodiments of the present disclosure, the wearable device generates the suggestion information of the current eyebrow shape based on the eyebrow shape matching coefficient in response that the matching coefficient is not within a preset coefficient range.

In some embodiments, the preset coefficient range may be customized according to the specific method of calculating the first matching coefficient. For example, in response that the first difference, the second difference, and the third difference are ratios, the wearable device may use the sum of the first difference, the second difference, and the third difference as the first matching coefficient of the current eyebrow shape and the recommended eyebrow shape. At this time, the larger the first matching coefficient, the greater the similarity between the current eyebrow shape and the recommended eyebrow shape. In response that the first matching coefficient is small, it indicates that the similarity between the current eyebrow shape and the recommended eyebrow shape is small. Thus, the wearable device may set a first matching coefficient threshold, and the preset coefficient range is a range in which the first matching coefficient is greater than or equal to the first matching coefficient threshold. In response that the first matching coefficient between the current eyebrow shape and the recommended eyebrow shape is less than the first matching coefficient threshold, the wearable device may determine that the first matching coefficient is not within the preset coefficient range. In this case, the wearable device may determine that the difference between the current eyebrow shape and the recommended eyebrow shape is large, and the similarity is small, and the suggestion information of the current eyebrow shape may be generated according to the recommended eyebrow shape to prompt the user to trim the current eyebrow shape in time.

For another example, the first difference, the second difference, and the third difference are in different forms. At this time, the wearable device may use the sum of the first difference, the second difference, and the third difference as the first matching coefficient between the current eyebrow shape and the recommended eyebrow shape, and the smaller the first matching coefficient, the greater the similarity between the current eyebrow shape and the recommended eyebrow shape. Thus, the wearable device may set a second matching coefficient threshold, and the preset coefficient range is a range in which the first matching coefficient is less than or equal to the second matching coefficient threshold. In response that the first matching coefficient between the current eyebrow shape and the recommended eyebrow shape is greater than the second coefficient threshold, the wearable device may determine that the first matching coefficient is not within the preset coefficient range. In this case, the wearable device may determine that the difference between the current eyebrow shape and the recommended eyebrow shape is large, and the similarity is small, and the suggestion information of the current eyebrow shape may be generated according to the recommended eyebrow shape to prompt the user to trim the current eyebrow shape in time.

In other embodiments, the wearable device may also trigger to generate the suggestion information for the current eyebrow shape in other ways, for example, by comparing the first parameter with the second parameter to obtain a parameter comparison result; in response that the parameter comparison result does not meet the preset requirements, the suggestion information for the current eyebrow shape is generated according to the recommended eyebrow shape.

In some embodiments, after generating suggestion information of the current eyebrow shape based on the first matching coefficient, the wearable device may prompt the user to perform operations such as trimming the current eyebrow shape according to the suggestion information. The way to prompt the user includes but is not limited to any one or more of play voice, display a text, prompt a vibration, flash a LED light, prompt SMS, send an email, etc.

In other embodiments, in response that the first matching coefficient is within the preset coefficient range, the suggestion information generated by the wearable device may include information on the current eyebrow shape adaptation, the first matching coefficient, and other information.

In one embodiment, the method for managing an eyebrow provided in an embodiment of the present disclosure, a wearable device is used to scan the user's head to determine the first face type of the user. Based on the preset recommendation rule and the first face type, a recommended eyebrow shape is determined. Among them, the recommended eyebrow shape may represent a better eyebrow shape suitable for the user's face shape. By calculating the first matching coefficient between the current eyebrow shape and the recommended eyebrow shape, the difference between the current eyebrow shape and the recommended eyebrow shape is determined, thereby generating suggestion information for trimming the current eyebrow shape. The method does not require photo input or video input, and by determining the recommended eyebrow shape based on the preset recommendation rule and the first face type of the user, and generating eyebrow suggestion information for the current eyebrow shape based on the first matching coefficient between the current eyebrow shape and the recommended eyebrow shape, the efficiency and accuracy for managing the eyebrow may be effectively improved.

It should be understood that the serial numbers of the steps in the above embodiments do not mean an order of execution. The execution order of each process should be determined by its function and internal logic, and should not constitute any limitation on the implementation process of the embodiments of the present disclosure.

Please refer to FIG. 8, which is a structural diagram of an eyebrow management device provided in the embodiment of the present disclosure, which may implement the details of the method for managing the eyebrow in the above embodiment and achieve the same effect. As shown in FIG. 8, eyebrow management device 10 may be applied to a wearable device with a data processing function. The eyebrow management device 10 includes: a scanning module 11 determining a first face type of a user by scanning a head of the user; a determination module 12 for determining a recommended eyebrow shape based on a preset recommendation rule and the first face type; a calculation module 13 for calculating a first matching coefficient between the recommended eyebrow shape and a current eyebrow shape; and a management module 14 for generating suggestion information for managing the current eyebrow shape based on the first matching coefficient.

The specific definition of the eyebrow management device 10 may be found in the definition of the method for managing the eyebrow above, which will not be repeated here. Each module in the above-mentioned eyebrow management device 10 may be implemented in whole or in part by software, hardware and a combination thereof. The above-mentioned modules may be embedded in or independent of the processor in the wearable device in the form of hardware, or may be stored in the storage device of the wearable device in the form of software, so that the processor may invoke and execute the operations corresponding to the above modules.

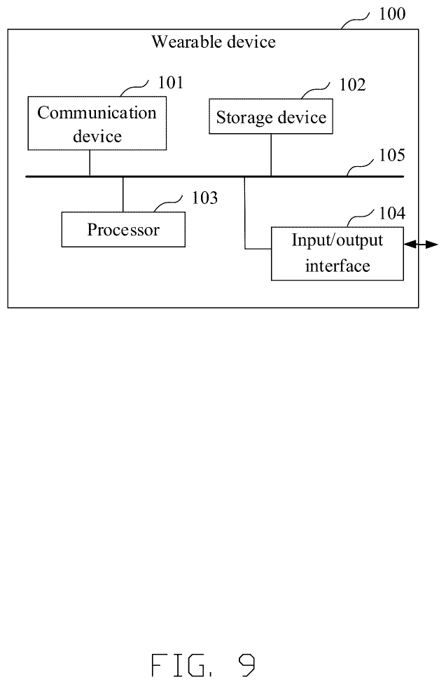

Please refer to FIG. 9, which is a schematic diagram of the structure of a wearable device 100 provided in an embodiment of the present disclosure. The wearable device 100 includes but is not limited to a pair of smart glasses, such as a pair of virtual reality (VR) glasses, a pair of augmented reality (AR) glasses, a pair of mixed reality (MR) glasses. The network in which the wearable device 100 is located includes but is not limited to the Internet, a wide area network, a metropolitan area network, a local area network, a virtual private network (VPN), etc.

As shown in FIG. 9, wearable device 100 includes a communication module 101, a storage device 102, a processor 103, an input/output interface 104, and a bus 105. The processor 103 is coupled to the communication module 101, the storage device 102, and the input/output interface 104 through the bus 105.

The communication module 101 may be a wireless communication module or a mobile communication module. The wireless communication module may provide wireless communication solutions including wireless local area networks (WLAN) (e.g., wireless fidelity (Wi-Fi) networks), Bluetooth (BT), global navigation satellite system (GNSS), frequency modulation (FM), near field communication (NFC), infrared (IR), etc., applied to the wearable device 100. The mobile communication module may provide wireless communication solutions including 2G/3G/4G/5G, etc., applied to the wearable device 100.

The storage device 102 may include one or more random access memories (RAM) and one or more non-volatile memories (NVM). The random-access memory may be directly read and written by the processor 103, and may be used to store executable programs (such as machine instructions) of the operating system or other running programs, and may also be used to store user and application data. The random-access memory may include a static random-access memory (SRAM), a dynamic random access memory (DRAM), a synchronous dynamic random access memory (SDRAM), a double data rate synchronous dynamic random access memory (DDR SDRAM, for example, the fifth generation DDR SDRAM is generally called DDR5 SDRAM), etc.

The non-volatile memory may also store executable programs and user data and application data, etc., and may be loaded into the random-access memory in advance for direct reading and writing by processor 103. The non-volatile memory may include a disk storage device and a flash memory.

The storage device 102 is used to store one or more computer programs. The one or more computer programs are configured to be executed by the processor 103. The one or more computer programs include multiple instructions, and when the multiple instructions are executed by the processor 103, the method for managing the eyebrow executed on the wearable device 100 may be implemented.

In other embodiments, the wearable device 100 further includes an external memory interface for connecting to an external memory to expand the storage capacity of the wearable device 100.

The processor 103 may include one or more processing units, for example, the processor 103 may include an application processor (AP), a modem processor, a graphics processor (GPU), an image signal processor (ISP), a controller, a video codec, a digital signal processor (DSP), a baseband processor, and/or a neural-network processing unit (NPU), etc. Different processing units may be independent devices or integrated into one or more processors.

The processor 103 provides computing and control capabilities. For example, the processor 103 is used to execute a computer program stored in the storage device 102 to implement the above-mentioned method for managing the eyebrow.

The input/output interface 104 is used to provide a way for user input or output. For example, the input/output interface 104 may be used to connect various input and output devices, such as a mouse, a keyboard, a touch device, a display screen, etc., so that the user may enter information or visualize information.

The bus 105 is at least used to provide a channel for mutual communication among the communication module 101, the storage device 102, the processor 103, and the input/output interface 104 of the wearable device 100.

It is understood that the structure illustrated in the embodiment of the present disclosure does not constitute a specific limitation on the wearable device 100. In other embodiments of the present disclosure, the wearable device 100 may include more or fewer components than shown in the figure, or combine some components, or split some components, or arrange the components differently. The components shown in the figure may be implemented in hardware, software, or a combination of software and hardware.

An embodiment of the present disclosure further provides a computer-readable storage medium, on which a computer program is stored. The computer program includes program instructions. The method implemented when the program instructions are executed may refer to the method for managing the eyebrow in the above-mentioned embodiments of the present disclosure.

The computer-readable storage medium may be an internal memory of the wearable device described in the above embodiment, such as a hard disk or memory of the wearable device. The computer-readable storage medium may also be an external storage device of the wearable device, such as a plug-in hard disk, a smart memory card (SMC), a secure digital (SD) card, a flash card, etc., equipped on the wearable device.

Furthermore, the computer-readable storage medium may mainly include a program storage area and a data storage area, wherein the program storage area may store an operating system, an application required for at least one function, etc. The data storage area may store data created according to the use of the wearable device, etc.

Finally, it should be noted that the above embodiments are only used to illustrate the technical solution of the present disclosure and are not intended to limit it. Although the present disclosure has been described in detail with reference to the preferred embodiments, a person of ordinary skill in the art should understand that the technical solution of the present disclosure may be modified or replaced by equivalents without departing from the spirit and scope of the technical solution of the present disclosure.

What is claimed is:

1. A method to manage an eyebrow, applied to a wearable device, the method comprising:
determining a first face type of a user by scanning a head of the user;
determining a recommended eyebrow shape based on a preset recommendation rule and the first face type;
calculating a first matching coefficient between the recommended eyebrow shape and a current eyebrow shape; and
generating suggestion information for managing the current eyebrow shape based on the first matching coefficient.

2. The method according to claim 1, wherein the determining the first face type of the user by scanning the head of the user comprises:
obtaining a digital human face shape of the user by scanning the head of the user;
determining a second face type of the digital human face shape based on a first face parameter of the digital human face shape;
determining the first face type of the user based on the second face type.

3. The method according to claim 2, wherein the determining the second face type of the digital human face shape based on the first face parameter of the digital human face shape comprises:
obtaining a second face parameter of a reference face shape from a preset facial database;
calculating a second matching coefficient between the digital human face shape and the reference face shape based on the first face parameter and the second face parameter;
determining a target reference face shape matched with the digital human face shape from the preset facial database based on the second matching coefficient;
determining the second face type based on a third face type of the target reference face shape.

4. The method according to claim 1, wherein the determining the recommended eyebrow shape based on the preset recommendation rule and the first face type comprises:
determining a target reference eyebrow shape matched with the first face shape from a preset eyebrow shape database according to a preset correspondence relationship, wherein the preset correspondence relationship comprises a correspondence relationship between face types and reference eyebrow shapes;
determining the recommended eyebrow shape based on a preferred eyebrow shape of the user and the target reference eyebrow shape.

5. The method according to claim 4, wherein the determining the recommended eyebrow shape based on a preferred eyebrow shape of the user and the target reference eyebrow shape comprises:
in response that a type of the preferred eyebrow shape is the same as a type of the target reference eyebrow shape, determining the preferred eyebrow shape or the target reference eyebrow shape to be the recommended eyebrow shape;
in response that the type of the preferred eyebrow shape is different from the type of the target reference eyebrow shape, determining the recommended eyebrow shape from the preferred eyebrow shape and the target reference eyebrow shape by sending a message to the user.

6. The method according to claim 1, wherein the calculating the first matching coefficient between the recommended eyebrow shape and the current eyebrow shape comprises:
obtaining a first parameter of the current eyebrow shape and a second parameter of the recommended eyebrow shape;
calculating the first matching coefficient between the recommended eyebrow shape and the current eyebrow shape according to the first parameter and the second parameter.

7. The method according to claim 6, wherein the first parameter comprises a first length, a first width, and a first arc radius of the current eyebrow shape, the second parameter comprises a second length, a second width, and a second arc radius of the recommended eyebrow shape, the calculating the first matching coefficient between the recommended eyebrow shape and the current eyebrow shape according to the first parameter and the second parameter comprises:
calculating a first difference between the first eyebrow length and the second eyebrow length based on a preset rule;
calculating a second difference between the first eyebrow width and the second eyebrow width based on the preset rule;
calculating a third difference between the first arc radius and the second arc radius based on the preset rule;
calculating the first matching coefficient between the recommended eyebrow shape and the current eyebrow shape according to the first difference, the second difference and the third difference.

8. The method according to claim 1, wherein the generating the suggestion information for managing the current eyebrow shape based on the matching coefficient comprises:
generating the suggestion information for managing the current eyebrow shape based on the recommended eyebrow shape in response that the matching coefficient is not within a preset coefficient range.

9. A wearable device comprising:
a storage device;
at least one processor; and
the storage device storing one or more programs that, when executed by the at least one processor, cause the at least one processor to:
determine a first face type of a user by scanning a head of the user;
determine a recommended eyebrow shape based on a preset recommendation rule and the first face type;
calculate a first matching coefficient between the recommended eyebrow shape and a current eyebrow shape; and
generate a suggestion information for managing the current eyebrow shape based on the first matching coefficient.

10. The wearable device according to claim 9, wherein the at least one processor determines the first face type of the user by scanning the head of the user by:
obtaining a digital human face shape of the user by scanning the head of the user;
determining a second face type of the digital human face shape based on a first face parameter of the digital human face shape;
determining the first face type of the user based on the second face type.

11. The wearable device according to claim 10, wherein the at least one processor determines the second face type of the digital human face shape based on the first face parameter of the digital human face shape by:
obtaining a second face parameter of a reference face shape from a preset facial database;
calculating a second matching coefficient between the digital human face shape and the reference face shape based on the first face parameter and the second face parameter;
determining a target reference face shape matched with the digital human face shape from the preset facial database based on the second matching coefficient;
determining the second face type based on a third face type of the target reference face shape.

12. The wearable device according to claim 9, wherein the at least one processor determines the recommended eyebrow shape based on the preset recommendation rule and the first face type by:
determining a target reference eyebrow shape matched with the first face shape from a preset eyebrow shape database according to a preset correspondence relationship, wherein the preset correspondence relationship comprises a correspondence relationship between face types and reference eyebrow shapes;
determining the recommended eyebrow shape based on a preferred eyebrow shape of the user and the target reference eyebrow shape.

13. The wearable device according to claim 12, wherein the at least one processor determines the recommended eyebrow shape based on a preferred eyebrow shape of the user and the target reference eyebrow shape by:
in response that a type of the preferred eyebrow shape is the same as a type of the target reference eyebrow shape, determining the preferred eyebrow shape or the target reference eyebrow shape to be the recommended eyebrow shape;
in response that the type of the preferred eyebrow shape is different from the type of the target reference eyebrow shape, determining the recommended eyebrow shape from the preferred eyebrow shape and the target reference eyebrow shape by sending a message to the user.

14. The wearable device according to claim 9, wherein the at least one processor calculates the first matching coefficient between the recommended eyebrow shape and the current eyebrow shape by:
obtaining a first parameter of the current eyebrow shape and a second parameter of the recommended eyebrow shape;
calculating the first matching coefficient between the recommended eyebrow shape and the current eyebrow shape according to the first parameter and the second parameter.

15. The wearable device according to claim 14, wherein the first parameter comprises a first length, a first width, and a first arc radius of the current eyebrow shape, the second parameter comprises a second length, a second width, and a second arc radius of the recommended eyebrow shape, the at least one processor calculates the first matching coefficient between the recommended eyebrow shape and the current eyebrow shape according to the first parameter and the second parameter by:
calculating a first difference between the first eyebrow length and the second eyebrow length based on a preset rule;
calculating a second difference between the first eyebrow width and the second eyebrow width based on the preset rule;
calculating a third difference between the first arc radius and the second arc radius based on the preset rule;
calculating the first matching coefficient between the recommended eyebrow shape and the current eyebrow shape according to the first difference, the second difference and the third difference.

16. A non-transitory storage medium having instructions stored thereon, when the instructions are executed by a processor of a wearable device, the processor is caused to perform a method for managing an eyebrow, wherein the method comprises:
determining a first face type of a user by scanning a head of the user;
determining a recommended eyebrow shape based on a preset recommendation rule and the first face type;
calculating a first matching coefficient between the recommended eyebrow shape and a current eyebrow shape; and
generating suggestion information for managing the current eyebrow shape based on the first matching coefficient.

17. The non-transitory storage medium according to claim 16, wherein the determining the first face type of the user by scanning the head of the user comprises:
obtaining a digital human face shape of the user by scanning the head of the user;
determining a second face type of the digital human face shape based on a first face parameter of the digital human face shape;
determining the first face type of the user based on the second face type.

18. The non-transitory storage medium according to claim 17, wherein the determining the second face type of the digital human face shape based on the first face parameter of the digital human face shape comprises:
obtaining a second face parameter of a reference face shape from a preset facial database;
calculating a second matching coefficient between the digital human face shape and the reference face shape based on the first face parameter and the second face parameter;
determining a target reference face shape matched with the digital human face shape from the preset facial database based on the second matching coefficient;
determining the second face type based on a third face type of the target reference face shape.

19. The non-transitory storage medium according to claim 16, wherein the determining the recommended eyebrow shape based on the preset recommendation rule and the first face type comprises:
determining a target reference eyebrow shape matched with the first face shape from a preset eyebrow shape database according to a preset correspondence relationship, wherein the preset correspondence relationship comprises a correspondence relationship between face types and reference eyebrow shapes;
determining the recommended eyebrow shape based on a preferred eyebrow shape of the user and the target reference eyebrow shape.

20. The non-transitory storage medium according to claim 19, wherein the determining the recommended eyebrow shape based on a preferred eyebrow shape of the user and the target reference eyebrow shape comprises:
in response that a type of the preferred eyebrow shape is the same as a type of the target reference eyebrow shape, determining the preferred eyebrow shape or the target reference eyebrow shape to be the recommended eyebrow shape;
in response that the type of the preferred eyebrow shape is different from the type of the target reference eyebrow shape, determining the recommended eyebrow shape from the preferred eyebrow shape and the target reference eyebrow shape by sending a message to the user.
